(19) United States
(12) Patent Application Publication
(10) Pub. No.: US 2005/0119875 A1
(43) Pub. Date: Jun. 2, 2005

(54) Identifying related names

(76) Inventors: Leonard Shaefer JR., Ashburn, VA (US); Richard Gillam, Herndon, VA (US); Frankie E. D. Patman, Bethesda, MD (US)

Correspondence Address: FISH & RICHARDSON P.C., 1425 K STREET, N.W., 11TH FLOOR, WASHINGTON, DC, 20005-3500, US

(21) Appl. No.: 10/942,792

(22) Filed: Sep. 17, 2004

Related U.S. Application Data
(63) Continuation-in-part of application No. 09/275,766, filed on Mar. 25, 1999.
(60) Provisional application No. 60/503,585, filed on Sep. 17, 2003.
(60) Provisional application No. 60/079,233, filed on Mar. 25, 1998.

(51) Int. Cl. G06F 17/28

(52) U.S. Cl. 704/7

(57) ABSTRACT

A system that identifies related names includes a datastore that persistently stores a collection of names. At least one name within the datastore is represented both by a native orthographic form of the name and by a transliterated form of the native orthographic form of the name. The system includes an input interface that is structured and arranged to receive at least an input name. A transliteration module is structured and arranged to produce at lease one transliterated form of the input name. An identifier is structured and arranged to identify at least one name from within the datastore that relates to the transliterated form of the input name. An output interface presents the at least one name identified from within the datastore as being related to the input name. This system may dynamically select the transliteration schema to be applied to the input name from among candidate potential transliteration schemas based on various criteria, including (1) characteristics of the input name such as geographic or linguistic indicators inherent thereto, (2) characteristics of a pool of names against which the input name is matched, and/or (3) data extrinsic to the input name or pool of names which may be useful in identifying geographic or linguistic characteristics of the party from whom the input name is received.

### CROSS REFERENCE TO RELATED APPLICATIONS

This application claims priority to U.S. Provisional Patent Application No. 60/503,585, filed Sep. 17, 2003. This application also is a continuation in part of U.S. patent application Ser. No. 09/275,766, filed Mar. 25, 1999, which claims benefit of U.S. Provisional Patent Application No. 60/079,233, filed Mar. 25, 1998. All of the above disclosures are incorporated by reference in their entirety.

### TECHNICAL FIELD

This document relates generally to the identification of related names.

### BACKGROUND

A database is a collection of information organized in such a way that a computer program can quickly and easily select desired pieces of data. A database typically includes a number of records, and each record includes one or more fields. Each field typically stores a single piece of information.

In such databases, retrieval of records that are associated with a person typically involves use of a unique identifying value or “key”, such as an ID number. For certain retrieval tasks, a unique identifying value is not always available, and the person's name itself must be used as the identifying value or “key”.

However, personal names have several limitations inhibiting their effectiveness as identifying values for retrieval of information from a database. For example, personal names are not unique. Numerous individuals may possess names with some or even all elements in common with many other individuals. In extreme cases, the same name may be commonly used by thousands or even millions of different people. Conversely, people who are closely related sometimes exhibit significant differences in the way each spells a commonly held family name. Moreover, a specific person may be represented in many different records with a database, and that person's name may be rendered in slightly or greatly differing forms within those database records.

Additionally, names are not used consistently. Within the U.S. society, as indeed in most societies around the world, individuals are permitted a certain degree of latitude in determining the form of the name they provide, orally or in writing, when providing information that is subsequently placed in a database.

Furthermore, names change over time. Names are social objects that are used to record various kinds of information, so they can be modified in various ways as time passes, in order to reflect changes in social or personal status by the bearer. In many Western societies, for example, names may change over time in order to reflect changes in marital status, educational or professional achievements, or even gender affiliation.

Yet another drawback of using personal names as a database key is that names are not consistently captured. Because it is more difficult to validate the spelling of names than it is to validate the spelling of most other words in a particular language, name information in a database is correspondingly subject to a greater incidence of spelling and keying errors.

Amplifying the difficulties associated with using personal names as identifiers, naming conventions tend to vary across cultures. It may not be appropriate to assume that the typical American name structure of single given name (first name), single middle name or initial followed by a surname (last name) applies to a database that contains names from all over the world. For instance, names from other cultures may have compound surnames or may be composed of only one name.

Moreover, between languages/cultures and within a single language/culture, names may have different forms and variations. Several variations of the same name may refer to a single person or entity. For example, a name may be spelled differently based on the language in which it is written, with different spellings referring to a single person. In addition, a person's name and its prefixes/suffixes may change in patterned, predictable ways as the result of an event, such as marriage, widowhood, or graduation from professional school. Similarly, typing errors or other sources of noise may create a variation on a name that is to refer to the same person as the original name. Rather than treating each variation of a name as referring to a distinct person or entity, it may be advantageous to match variations of a name that may all refer to the same person.

### SUMMARY

In one general aspect, a system that identifies related names includes a datastore that persistently stores a collection of names. At least one name within the datastore is represented both by a native orthographic form (NOF) of the name and by a transliterated form of the native orthographic form of the name. The system includes an input interface that is structured and arranged to receive an input name. A transliteration module is structured and arranged to produce at lease one transliterated form of the input name. An identifier is structured and arranged to identify at least one name from within the datastore that relates to the transliterated form of the input name. An output interface presents the at least one name identified from within the datastore as being related to the input name.

Implementations of this aspect may include one or more of the following exemplary features. At least one of the names in the datastore may be derived through transliteration of a native orthographic form of the name. In the datastore, at least one name is represented by the native orthographic form using a romanized or non-romanized version of the name and by the transliterated form using a romanized or non-romanized version of the name. Where the input name is received in the native orthographic form (for example Cyrillic, Arabic, Chinese, Hangul, Roman, or Greek written forms, or extensions thereof), one or more romanized forms of the input name may be generated from the native orthographic form of the input name received.

The transliteration module may produce multiple transliterated forms of a single input name, many or each of which being used to identify related names from within the datastore.

The transliterated form of the input name may be matched against similar forms of names stored in the datastore. A score may be assigned to each of the similar forms of names that matches the transliterated form of the input name. Each of the scores may indicate a quality of match between the transliterated form of the input name and the corresponding similar form. If the transliterated form of the input name is roman and the transliterated form of the names stored in the datastore is roman, the roman form of the input name is matched against the roman form of names stored in the datastore. Conversely, if the transliterated form of the input name is non-roman and the transliterated form of the names stored in the datastore is non-roman, the non-roman form of the input name is matched against the non-roman form of names stored in the datastore.

Native orthographic forms stored by the datastore may be identified as corresponding to transliterated forms of one or more names within the datastore determined to match the transliterated form of the input name. The results produced include one or more of the transliterated or native orthographic forms of the names within the datastore that are determined to match the transliterated form of the input name.

In another general aspect, the system may dynamically select the transliteration schema to be applied to the input name from among candidate potential transliteration schemas based on various criteria, including, for example: (1) characteristics of the input name such as geographic or linguistic indicators inherent thereto, (2) characteristics of a pool of names against which the input name is matched, and/or (3) data extrinsic to the input name or pool of names which may be useful in identifying geographic or linguistic characteristics of the party from whom the input name is received. As such, a system that identifies related names includes a datastore that persistently stores a collection of names. The system includes an input interface that is structured and arranged to receive an input name. A transliteration module is structured and arranged to apply a dynamically selected transliteration schema to produce at least one transliterated form of the input name, where the transliteration schema is dynamically selected by a module from among several transliteration schemas available for application to the input name. An identifier is structured and arranged to identify at least one name from within the datastore that relates to the transliterated form of the input name. An output interface presents the at least one name identified from within the datastore as being related to the input name.

In addition to those indicated above with respect to the other aspect, implementations of this aspect may include one or more of the following exemplary features. The module for dynamically selecting the transliteration schema may include a module for determining a characteristic of the input name, and a module for selecting the transliteration schema to be applied to the input name from among several available transliteration schemas based on the determined characteristic of the input name. The determined characteristic of the input name may include a candidate native orthographic form for the input name, which candidate may be determined based on range of Unicode associated with one or more characters of the input name.

Furthermore, independent characteristics may be determined for more than one segment of the input name, where segments of the input name independently correspond to different names within the entire input name. For instance, a first characteristic may be determined for a first segment of the input name and a second characteristic may be determined for a second segment of the input name, with the first and second characteristics differing. In one implementation, the first characteristic corresponds to a first candidate native orthographic form and the second characteristic corresponds to a second candidate native orthographic form that differs from the first candidate native orthographic form. In each instance, the first and second candidate native orthographic forms may represent native orthographic forms within a single language.

Additionally or alternatively, the module for dynamically selecting the transliteration schema may include a module for determining characteristics of the names within the datastore, and a module for selecting the transliteration schema to be applied to the input name from among several available transliteration schemas based on the determined characteristic of the names within the datastore. The module for determining characteristics of names within the datastore may be structured and arranged to identify one or more particular transliteration forms of native orthographic forms of the stored names that appear frequently relative to other transliteration forms, and the module for selecting the transliteration schema to be applied to the input name may be structured and arranged to select a transliteration schema corresponding to the one or more particular transliteration forms identified.

Yet again additionally or alternatively, the module for dynamically selecting the transliteration module may include a module for receiving extrinsic data related to the native orthographic form of the input name, and a module for selecting the transliteration schema to be applied to the input name from among several available transliteration schemas based on the received extrinsic data. The extrinsic data may include geographic data related to a person from whom the input name is received, such as information derived from a identifying documents presented by the person, such as a passport, a visa, a green card, or a driver's license.

These general and specific aspects may be implemented using a system, a method, or a computer program, or any combination of systems, methods, and computer programs.

Other features will be apparent from the description and drawings, and from the claims.

### DESCRIPTION OF DRAWINGS

FIGS. 1A, 1B, and 1C are block diagrams illustrating the structure, arrangement, and operation of exemplary systems capable of identifying related or matching names, such as versions of a name that may be used in one or more languages.

FIG. 1D is a schematic diagram illustrating the contents of a database containing names in a native orthographic form as well as a transliterated form of the native orthographic form.

FIGS. 2 and 3 are flow charts illustrating exemplary processes for identifying related names.

FIGS. 4, 5, and 6 illustrate exemplary interfaces used to enable input and output with respect to a user seeking to identify related names.

### DETAILED DESCRIPTION

Various native orthographic forms of an input name may be conveniently matched using a single search utility that is capable of transliterating names from several different native orthographic forms to a common domain in which characteristics shared among the names can be identified. Such a search utility may benefit from an ability to accommodate the input of names in their received or native orthographic form, notwithstanding the form of the stored names against which they will be matched. Specifically, because transliteration of a single name from its native orthographic form into another form often properly results in several different candidate names, such a utility allows for the identification of each different candidate name and thus the determination of matches for each different candidate name.

It also may be useful to enable perception of names in their native orthographic form when providing output from such a search utility, notwithstanding the form of those names used to determine whether they match an input name. For instance, enabling perception of matching names in their native orthographic form may enable identification of actual identities who have been previously encountered and who relate to the romanized version of a database entry. This type of output enables perception of names in the native orthographic form used to present the input name, which may be highly relevant or recognizable to a particular searcher or search application.

Transliteration of input names and stored target data alike may be particularly effective for a search utility capable of identifying and accounting for characteristics of the transliterations performed on the different native orthographic forms. Furthermore, the transliteration schema(s) to be applied to input names by the search tool may be dynamically selected based on: (1) characteristics of the input name such as geographic or linguistic indicators inherent thereto, (2) characteristics of a pool of names against which the input name is matched, and/or (3) data extrinsic to the input name or pool of names which may be useful in identifying geographic or linguistic characteristics of the party from whom the input name is received.

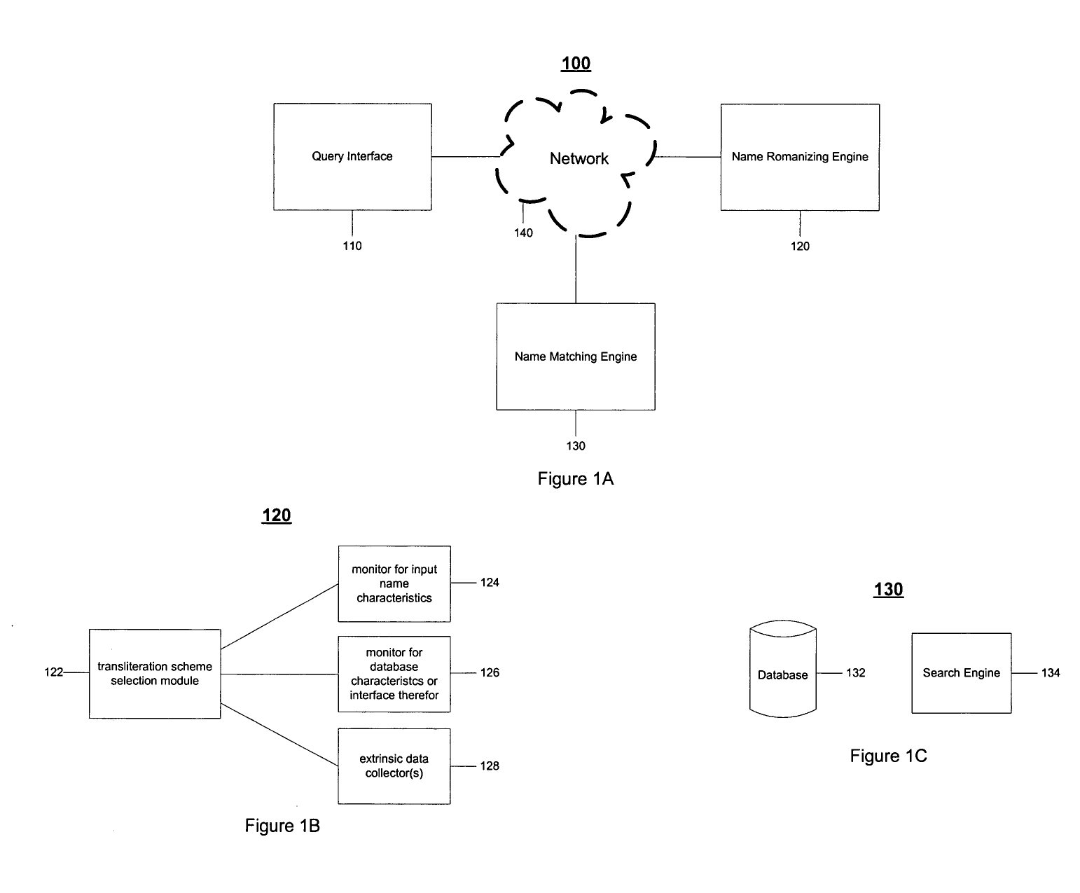

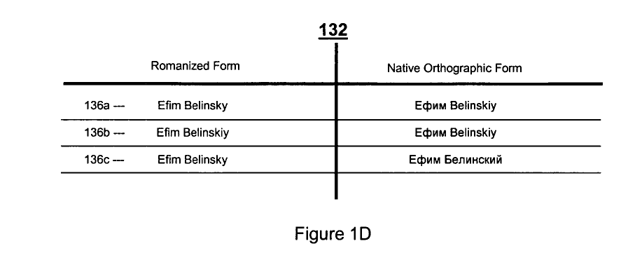

Referring to FIG. 1A, a search tool system 100 capable of identifying versions of a name input in its native orthographic form includes a query interface 110, a name transliteration engine 120, a name matching engine 130, and a network 140 enabling communications there between.

Query interface 110, which is also known as an output interface, is configured to receive an input name to be searched from a user and to display the results of the search from the user. Query interface 110 also may include an application programming interface (API) that includes one or more input/output relationships that indicate how versions of the input name may be identified. More particularly, the relationships specified by the API may be used to provide input names and to receive names related to the input names. For example, the API may include a relationship whose inputs are an input name and a name of an encoding scheme of the input name, which represents symbolic values for the characters of the input name. The relationship optionally may take a language and a culture of the input name as inputs. The outputs of the relationship may be one or more names related to the input name. The related names may be identified based on the encoding scheme, the language, or the culture that are provided as inputs to the relationship. If the language and culture are not provided as inputs, they may be automatically identified based on the input name and the encoding scheme that are provided as inputs.

While identifying the related names, one or more encoding schemes for the related names and one or more transliteration standards or schemas to be applied to the input name and the related names may be automatically identified. Alternatively or additionally, query interface 110 may enable the manual selection of the encoding schemes and the transliteration schemas. If no encoding schemes are automatically identified or manually selected, a default encoding scheme may be used.

Query interface 110 may be implemented using a general-purpose computer, a special purpose computer, or a PDA. As such, query interface 110 generally includes one or more input devices, such as a keyboard, mouse, stylus, or microphone, as well as one or more output devices, such as a monitor, touch screen, speakers, or a printer. If query interface 110 is a separable component, as illustrated by FIG. 1A but not required, it may leverage network 140 in communicating with name transliteration engine 120.

Name transliteration engine 120 is configured to receive an input name, typically from query interface 110, and to produce one or more transliterated forms of that input name. In one implementation, name transliteration engine 120 produces one or more romanized forms of the input name. The name transliteration engine 120 may be configured to romanize names from some or all of the languages capable of being represented by the Unicode encoding scheme. Multiple distinct romanizing schemes may be available for each of the languages that can be represented by the Unicode encoding scheme. For instance, Chinese may be romanized using the Pinyin or Wade-Giles techniques, either or both of which may be employed by name transliteration engine 120 to romanize names that are input in their native orthographic form of Chinese. Transliterated names created by the name transliteration engine 120 are communicated to name matching engine 130.

Name matching engine 130 is configured to identify one or more matching or related names for the transliterated names produced from name transliteration engine 120, and to provide the same for presentation by query interface 110. For example, in implementations where name transliteration engine 120 produces romanized forms of the input name, name matching engine 130 identifies one or more matching or related names for the romanized names received from name transliteration engine 120. Examples of name matching engine 130 are described in U.S. patent application Ser. No. 09/275,766, filed Mar. 25, 1999, and U.S. Provisional Patent Application No. 60/079,233, filed Mar. 25, 1998, each disclosure being incorporated by reference in its entirety.

Query interface 110, name transliteration engine 120, and name matching engine 130 optionally may operate on separate computer systems and be connected using network 140. Network 140 typically includes a series of portals interconnected through a coherent system. Examples of network 140 include the Internet, Wide Area Networks (WANs), Local Area Networks (LANs), analog or digital wired and wireless telephone networks (for example a Public Switched Telephone Network (PSTN)), an Integrated Services Digital Network (ISDN), or a Digital Subscriber Line (xDSL)), or any other wired or wireless network. Network 140 may include multiple networks or sub-networks, each of which may include, for example, a wired or wireless data pathway. When network 140 is included, each of the computer systems on which query interface 110, name transliteration engine 120, and name matching engine 130 operate includes a communications interface (not shown) used to send communications through network 140. The communications may include e-mail, audio data, video data, general binary data, or text data. Alternatively, query interface 110, name transliteration engine 120, and name matching engine 130 may be modules operating on a single computer system that effectively communicate over a bus within the single computer system. In such implementations, the network 140 is the bus over which the modules communicate.

Referring to FIG. 1B, an implementation of name transliteration engine 120 is described as including transliteration schema selection module 122, characteristics monitors 124 and 126, and extrinsic data collector 128. Transliteration schema selection module 122 is configured to select among available transliteration schemas based on monitored input from each of 124, 126 and 128. Name transliteration engine 120 uses the selected transliteration schema to transliterate an input name received by name transliteration engine 120.

Characteristics monitor 124 monitors for input name characteristics. For instance, where an input name is provided in Unicode, characters within the input name may be evaluated and assigned a numerical Unicode score, and collectively, the Unicode scores for the evaluated characters may be used to predict characteristics (for example geographic or linguistic) of the name input. For example, if the Unicode scores of the characters of the input name indicate that the input name, or parts thereof, is specified in the Cyrillic alphabet, the monitor 124 may indicate that the input name, or the parts thereof, is a Russian name. Such a determination of the language of a name based on the characters used to spell the name may not be correct in all instances, since names of a particular language may be spelled with characters of an alphabet that does not correspond to the particular language. When a correct determination of the geographic or linguistic characteristics of the input name is made, such characteristics may be used by the transliteration schema selection module 122 to identify dynamically one or more transliteration schemas appropriate for the input name, or partial segments thereof (which may or may not be applied to the entire name).

Similarly, monitor 126 may be configured to monitor characteristics of data stored or accessed by name matching engine 130. For instance, monitor 126 may be configured to discern, identify and/or determine disproportionalities among database data, and to enable selection of transliteration schemas that take advantage of such disproporationalities where appropriate. In one implementation, a transliteration scheme may be selected for transliterating an input name when the same transliteration scheme is determined by monitor 126 to have been used in transliterating a significant or disproportionate number of names within the database. Conversely, a transliteration scheme may be avoided, where advantageous based on characteristics of the data stored or accessed by name matching engine 130.

Extrinsic data collector 128 is configured to detect or collect extrinsic data that may impact a selection of transliteration schemas. For instance, in one implementation, extrinsic data collector 128 includes an interface for collecting data regarding or contained within a traveler's identifying documents, such as a passport of the traveler that includes origin and destination information and countries of visitation, which may be used by transliteration schema selection module 222 as a factor in determining the set of transliteration schemas for languages associated with one or more of those countries.

Transliteration schema selection module 122 uses information produced by monitors 124 and 126 and data collector 128 to select one or more transliteration schemas appropriate to transliterate a name received by name transliteration engine 120. If the produced information does not absolutely identify a single transliteration schema to be applied to the input name, multiple transliteration schemas may be identified and applied to the input name. For example, multiple romanization schemas may be identified for and applied to the input name [symbol] [symbol] to produce Efim Belinski, Yefim Byelinsky, and Efime Bielinski as possible romanized forms of the input name. In one implementation, the multiple transliterated forms of the input name are used to identify names related to the input name. One or more names that are related to any one of the multiple transliterated forms may be identified as related to the input name. Alternatively, one or more names that best match one of the multiple transliterated forms may be identified as related to the input name. For example, more names that match the transliterated form Efim Belinski may be identified than names that match the transliterated forms Yefim Byelinsky and Efime Bielinski. Therefore, the names matching Efim Belinski may be identified as related to the input name [symbol] [symbol] . In addition, the transliteration schema that produced the transliterated form Efim Belinski may be selected as more appropriate for application to future input names than the transliteration schemas that produced the transliterated forms Yefim Byelinsky and Efime Bielinski. Such a selection may be particularly useful when the future input names are of a similar language or culture of the input name to which the multiple transliteration schema were applied originally.

Moreover, the transliteration of the input name using a selected transliteration schema may lead to the identification of an additional transliteration schema to be applied to the input name or future input names. For example, the input name [symbol] [symbol] may be romanized to produce the transliterated form Efim Belinski, and transliterated names from that are related to the transliterated form Efim Belinski are identified. Characteristics of the related names may indicate that one or more other transliteration schemas that are different from the transliteration schema used to produce the transliterated form Efim Belinski were used to produce the related names. The one or more other transliteration schema may be applied to the input name to produce different transliterated forms for which additional related names may be identified. The different transliterated forms may match the related names more fully or accurately than the originally transliterated form. In addition, the different transliterated forms may be related to additional names that are not related to the originally transliterated form. In one implementation, only the additional names related to the different transliterated forms may be identified as related to the input name. In another implementation, both the additional names related to the different transliterated forms and the names related to the originally transliterated form may be identified as related to the input name, particularly when at least one name related to the originally transliterated form is not a name that is related to one of the different transliterated forms, or vice versa.

A module for identifying characteristics of the transliterated name may be used after the initial transliteration, and different transliteration schemas may be selected for application to the input name based on the identified characteristics. Any number of transliteration schemas may be applied to the input name and the transliterated forms thereof through repeated identification of characteristics of the input name and application of a transliteration schema to the input name that is appropriate for the identified characteristics. For example, a name written in the Cyrillic alphabet may be non-Russian name, even though characteristics module 124 may indicate that the name is a Russian name. A transliteration schema appropriate for non-Russian names written in the Cyrillic alphabet may be identified and used to transliterate either the input name of the transliterated form of the input name once the determination that the input name is not a Russian name is made. As another example, if names that are received by name transliteration engine 120 or that match the received names are predominantly of a single type, a common transliteration schema appropriate for names of the single type may be applied to future input names automatically or by default without further identification of the common transliteration schema as otherwise appropriate for the future input names.

Referring to FIG. 1C, an implementation of name matching engine 230 is described as including database 132 and search engine 134. Database 132 contains names in various languages, both in their native orthographic form and in their romanized form, as illustrated by FIG. 1D. All names with an NOF that is not in the roman writing system are romanized with the name transliteration engine 120, and the romanized forms are stored in the database 132 along with the NOF. The NOF of each name is romanized in a non-deterministic manner such that the origin of the name may not be determined. All names with an NOF that is in the roman writing system are simply stored in the database 132.

As shown in FIG. 1D, the romanization of a name corresponds to a transliteration of the native orthographic form into a roman writing system form of the name. Database records 136a-136c each contain a romanized form of a name and the native orthographic form of the name. There may exist only one native orthographic form for a romanized form of a name. For example, database 132 only contains one native orthographic form of the romanized name “Efim Belinskiy” that is associated with record 136b. Similarly, there may only be one romanized form for multiple native orthographic forms of names. For example, database 132 has two records 136a and 136c with a romanized form of “Efim Belinsky.” However, records 136a and 136c have different native orthographic forms. Finally, there may exist multiple romanized forms for a single NOF. For example, records 136a and 136b contain two different romanizations of the Cyrillic name “ [symbol] Belinskiy.”

Furthermore, parts of the a name may have different origins or languages such that different transliteration schemas are appropriate for application to each of the parts. For example, a given name and a family name of a particular name may have different origins such that a first transliteration schema may be appropriate for the given name and a second transliteration schema may be appropriate for the family name. The database 132 may include records that relate transliterated and native orthographic forms of individual parts of names instead of or in addition to records that apply to full names. In addition, one or more transliteration schemas may be identified for each part of a name received by name transliteration engine 120, and the transliteration schemas may be applied to the corresponding parts of the name. Handling parts of the name separately may result in a relatively large number of possible matches in the database 132 for names received by name transliteration device 120.

Separate handling of names by the database 132 and by name transliteration engine 120 may be particularly useful in situations where people use different orthographies of one or more parts of the name in order to avoid detection. For example, a person that normally uses Chinese given and family names may use an English form of a Chinese given name while continuing to use a Chinese Family name in an attempt to avoid detection. The database 132 and name transliteration engine 120 may not relate the changed name to the actual name of the person when names are handled as monolithic units, but may do so if the parts of the name are handled individually.

With names stored in their romanized form, it is possible to leverage the database as a common comparison medium that can be used to test whether names match one another. Additionally, with names being maintained in their native orthographic form, it is possible for the matching names to be returned in their original form, providing a means to present examples of literal names processed by the search tool or developers of database 132. As will be described hereinafter with respect to processes 200 and 300, the database 132 can return one or more entries that match an input with particularity, and it also may be able to return entries that differ from the input as a result of character variations and cultural variations. Character variations may include, for example, typos, noise, concatenations, truncations, and initials. Cultural variations, for example, may include the addition of titles, suffixes, prefixes, qualifiers, and infixes, as well as nicknames, cultural variants, and the presence or absence of certain name-parts.

Search engine 134 is configured to search database 132 and retrieve the entries from database 132 that match or otherwise relate to the romanized version of the input name received through query interface 110. Each matching name produced by search engine 134 is assigned a score that is useful in rating the quality of the match. The score derived by the search engine 134 for a transliterated name in the database represents a composite assessment of numerous cultural and linguistic factors, as well as general noise-cancellation and string-similarity measures that are considered in attempting to account for the absolute differences between the input name and the transliterated name.

The matching entries, along with their scores, then are sent to query interface 110 for presentation. In one implementation, the name matching engine 130 includes a utility such as NameHunter™, which has access to rules and data capable of identifying and accounting for variations introduced through transliterations of names from various native orthographic forms to romanized forms.

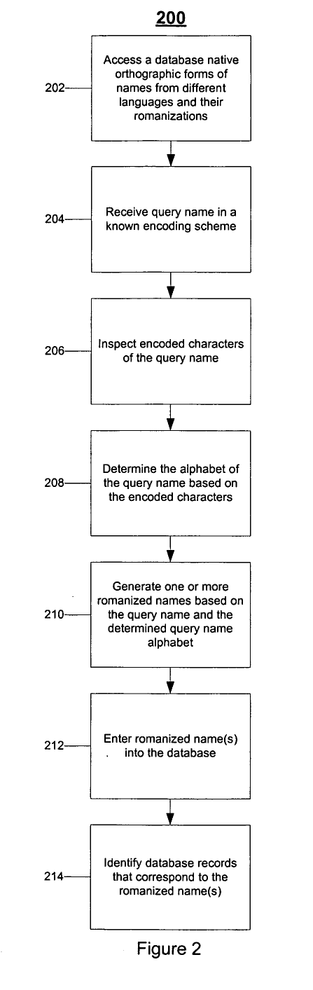

Referring to the process 200 of FIG. 2, one or more variations of an input name are identified from within a database of names. A database of the native orthographic form of names from different languages (that is native orthographic forms) and their romanizations is maintained (202), and the input name to be searched is received in a known encoding scheme (204). The input name can have multiple segments, corresponding to a given, middle, and last name. The encoding scheme of the input name maps characters to numbers, so each character can be said to have a value. Examples of the encoding scheme include the American Standard Code for Information Interchange (ASCII) encoding scheme and the Unicode encoding scheme. The ASCII encoding scheme represents words in the roman writing system, and therefore may require no transliteration to roman. Alternatively, a name may be transliterated within a single writing system, for example, to account for different spellings of the name in the single writing system. The different spellings of the name may correspond to different languages or cultures that use the single writing system. For example, a name may have a different spelling in English and Spanish, even though English and Spanish both use the roman writing system. In such a case, a name may be transliterated from English to Spanish, or vice versa. As another example, characters within names may be rendered differently in different locations, languages, and cultures. For example, the ess-zet character is rendered as “β” in German orthography, which uses the roman alphabet, and as “ss”, in other romaniform orthographies. Transliteration within the roman writing system may be used to convert “β” to “ss”, and vice versa, thus enabling transliteration to account for different spellings of a name within a single writing system.

Conversely, the Unicode encoding scheme, which subsumes the symbols covered by the ASCII encoding scheme, is capable of representing symbols in various different writing systems including but not limited to the roman writing system. Particularly, the symbols of each writing system tend to be represented using Unicode values within a distinct and identifiable range. Therefore, if an input name is encoded in the Unicode encoding scheme, its corresponding writing system can be determined from the range of Unicode values used to represent the symbols of the name. Names may be transliterated between different writing systems that may be represented by the Unicode encoding scheme. The different writing systems may be used by different languages or cultures, by a single language or culture, or some combination thereof. Other encoding systems include Universal Transfer Format 8 (UTF-8), KOI-8, and KOI-9. A list of encoding systems may be found at http://www.iana.org/assignments/character-sets.

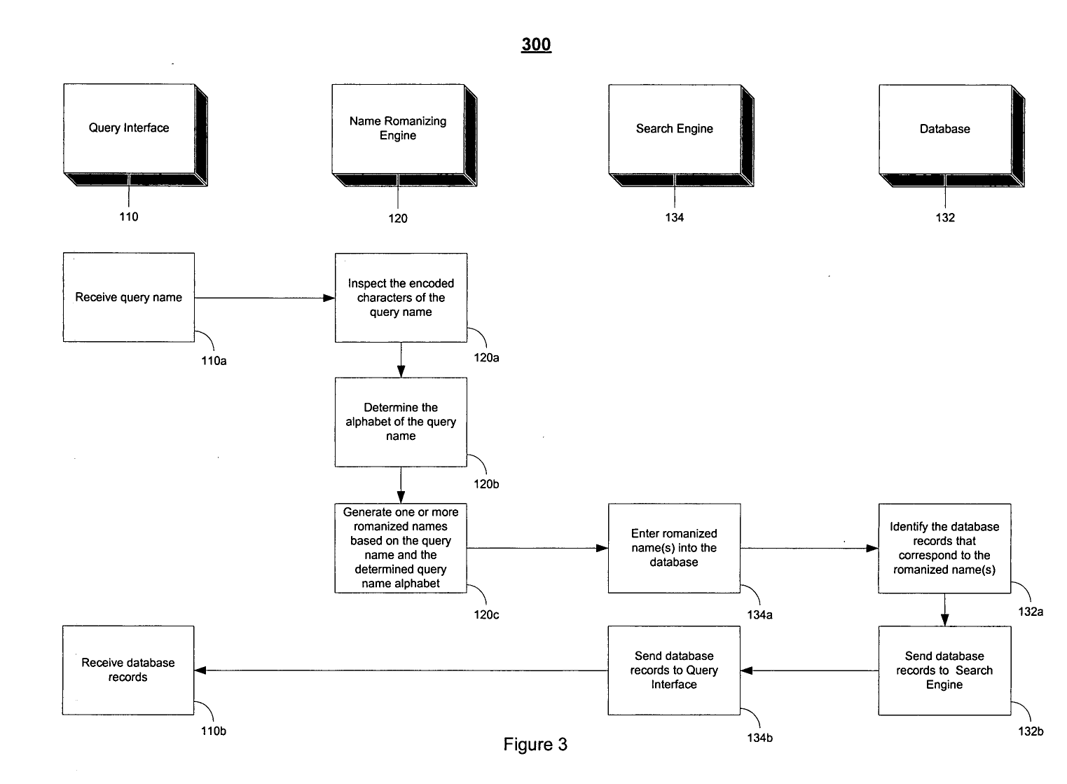

For ease of explanation, the remainder of the FIGS. 2 and 3 processes are described with respect to a Unicode encoding scheme implementation. Within this implementation, the symbols of the query name to be searched are inspected (206). If their corresponding values fall into a range that is characteristic of a particular writing system represented by the Unicode encoding scheme, the query name is determined to have that writing system as its native orthographic form (208). Otherwise, other processes may be employed to determine an appropriate transliteration scheme to be applied to the input name. This determination is then combined with other linguistic and cultural properties discerned in the name, as well as other extrinsic factors as may be available.

One or more romanized names are generated based on the query name and the writing system of the query name (210). One or more romanization techniques are used to create the romanized names from the query input. These romanization techniques convert characters or sets of characters of the origin writing system to characters or sets of characters of the roman writing system. Each romanization technique may romanize the input name in a different way. In addition, each romanization technique may produce multiple romanizations of the input. The romanization process (210) therefore may and typically does yield a set of romanized forms of the input name to be searched.

Romanized names created from the input name are matched against all romanized names in the database of names from different languages (212), and the entries in the database that match the romanized names are identified and returned (214). Each of the romanized names is independently matched against the names in the database, and one or more stored and matching names is retrieved for each input romanized name. The returned and matching names are aggregated and returned, and each is scored based on the quality of its match with the input name. Thus names contained within the database that match the query name are returned.

The task of inspecting the characters of the query name in order to determine its writing system (206 and 208) may be optional. The determination of the writing system of the name may be made differently. For example, the writing system of the name can be manually specified when the input name is entered.

As inferred by the description of the FIG. 2 process, the exact romanization techniques employed may be determined dynamically. For instance, in one implementation, the process 200 of FIG. 2 may be supplemented or modified to include processes for monitoring characteristics and/or data capable of informing dynamic selection of a transliteration schema, and selection of such a transliteration schema based on the monitored characteristics. Moreover, three factors that can be considered when dynamically choosing a romanization technique include: (1) characteristics of the input name such as geographic or linguistic indicators inherent thereto, (2) characteristics of a pool of names against which the input name is matched, and/or (3) data extrinsic to the input name or pool of names which may be useful in identifying geographic or linguistic characteristics of the party from whom the input name is received.

One influence on the selection of the romanization technique used to transliterate the input name is the characteristics of the input name itself. For example, some Chinese names have elements that reflect Christian influence. These Chinese names are most accurately transliterated to the roman writing system by a specific romanization technique. Detection of the Christian influence in the Chinese name could lead to a dynamic decision to transliterate using the specialized transliteration technique. In general, names corresponding to cultures historically under western influence, such as Hong Kong, often may have attributes indicating the western influence. Transliteration schemas that appropriately account for the western influence may be identified as most appropriate for application to the influenced names.

Second, the information stored in the database itself can signal which romanization technique will mostly likely yield good matches in the database. If 80% of the romanized forms of the names in the database were created with a particular romanization technique, then romanizing the query name with that same technique will probably lead to matches being found in the database.

Third, the origin of the name can be used as a basis for dynamically selecting which of several available romanization techniques should be used in a particular circumstance. For example, if a certain transliteration technique is always used to romanize the names found in Chinese passports, the romanization technique specifically used in Chinese passports should be employed to transliterate an input name known to have been derived from a Chinese passport. These three factors, in addition to the writing system associated with the NOF, the language(s) and culture(s) in which that writing system is used, and the nature and relative populations of those.

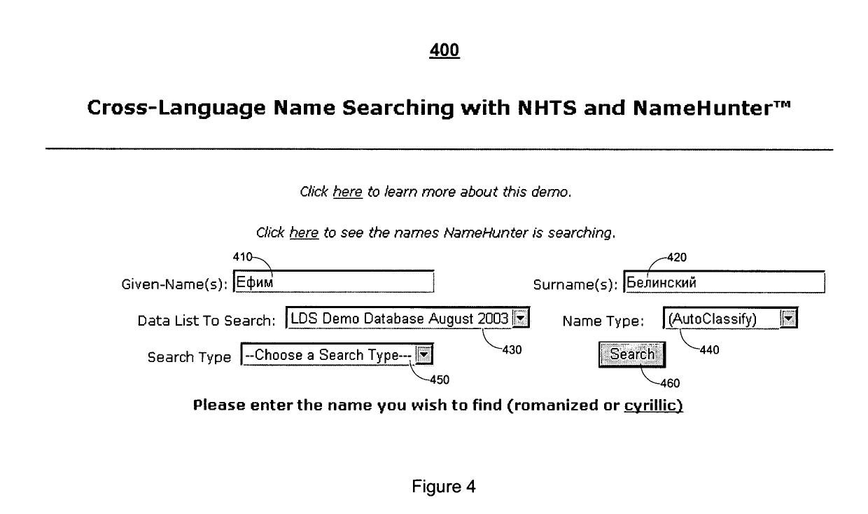

FIG. 3 illustrates a process 300 that leverages the componentry of FIGS. 1A-1C and interfaces shown by FIGS. 4-6 to identify versions of a name that is input in its native orthographic form from among variations of that name which are derived from other native orthographic forms and stored in a database. In process 300, query interface 110 receives a query name for which the matching variations are desired (110a). For example, as illustrated in and further described with respect to FIG. 4, a query for the name “efim belinsky” may be received at a user interface 400.

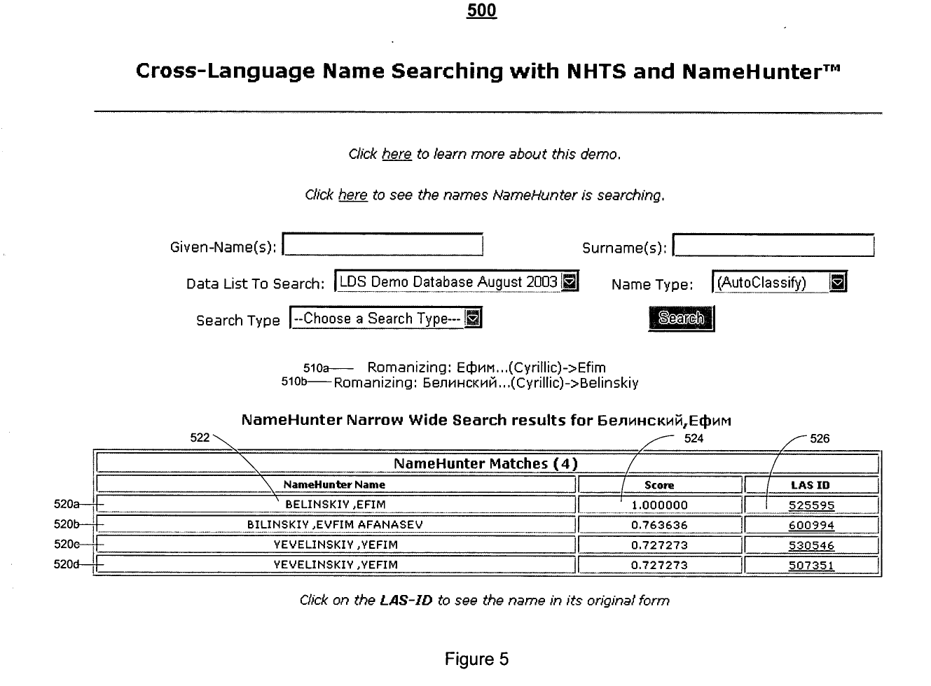

The query interface 110 passes the query name on to the name transliteration engine 120, which inspects the encoded characters of the query name to determine/identify characteristics of the query name based on its encoding scheme (120a). For example, the encoding scheme may be identified when the name is input, it may be specified beforehand, or otherwise. Based on the characters used in the query name, the name transliteration engine 120 determines the writing system used to create the query name (120b). In the above example, this inspection leads to the conclusion that the name “efim belinsky” is written using the roman writing system, as illustrated in and further described with respect to FIG. 5.

With knowledge of the writing system used to write the input name, name transliteration engine 120 generates one or more romanized names based on the query name and the writing system used to create the query name (120c). The romanized names are generated using a romanization technique that transliterates the query name from its native orthographic form to its romanized forms. In the above example, the name “efim belinsky” does not change as a result of romanization, because it was already in the roman writing system.

Next, the romanized name(s) are automatically entered into the database 132 by the search engine 134 (134a), generally without requiring specific user input and perhaps without notification to the user. The database 132 matches the romanized input(s) with its romanized records and identifies database records accordingly (132a). These records, or the roman or native orthographic form(s) of the name(s) corresponding thereto, are made available to the search engine 134 (132b) and ultimately the query interface 110 (134b). The query interface 110 presents the results (110b) according to user input. In this manner, any records from the database 132 that matched the romanized name “efim belinsky” will be returned to the query interface 110, in their romanized form and/or their various native orthographic forms. In the above illustration, if “efim belinsky” matched romanized versions of a Chinese native orthographic form, either or both of the romanized or native orthographic form could be presented to the user, as could other results determined to relate to the Chinese matches.

Referring to FIG. 4, an interface 400 enables a query for names matching a Cyrillic input. The interface 400 contains text boxes 410 and 420 that can be used to specify the query name. The text box 410 can be used to specify the given name(s), while the text box 420 can be used to specify the surname(s). The name “ [symbol] ” has been entered into the text box 410 for given names, and the name “ [symbol] ” has been entered into the text box 420 for surnames. Selection boxes 430, 440, and 450 allow the user to specify some options for the query. Database selection box 430 allows the user to choose which name database to search. Name type selection box 440 allows the user to manually specify the culture of the query name in the event that automatic determination is not desired. Alphabets, such as Arabic and Chinese, may be chosen in name type selection box 440. The “Auto-Classify” option of selection box 440 signals for automatic determination of the culture of the entered query name.

Search type selection box 450 allows the user to specify which type of search in the database to run. Each option in the search type selection box 450 defines a method or criteria for identifying names that are related to the query name specified in the text boxes 410 and 420. In one implementation, three search types can be chosen from the search type selection box 450: narrow, medium, and wide. A narrow search applies the most stringent criteria to the matching and ranking process, so that only names that closely resemble the query name in the number, order, and spelling of the name components will qualify as matches. A medium search is slightly more tolerant of differences in spelling, syntax (order), and number of name-components. This search also supports consideration of equivalent names, such as nicknames, for many common given names. A wide search is the most tolerant of differences in spelling, syntax (order), and number of components. This search typically returns the greatest number of matches, some with only a vague resemblance to the query name.

When selected, a “Search” button 460 submits the query specified by the information entered and selected in the input fields 410-450. Clicking the “Search” button 460 will submit a query of the “Demo Database August 2003” database with a default value for the type of search, such as, for example, a narrow search for the name “ [symbol] [symbol] ”. The culture used in the name “ [symbol] [symbol] ” is left for automatic determination.

Referring to FIG. 5, an interface 500 shows intermediate results of the query. Initially, the romanized names are created from the query name “ [symbol] [symbol] ,” which is written in the Cyrillic writing system. Line 510a indicates that the romanization of “ [symbol] ” from the Cyrillic writing system is “Efim”. Likewise, line 510b says that the romanization of “ [symbol] . ” is “Belinskiy.”

These romanized names are then matched against the database of names, and database records that match the romanized names are returned. In this case, 4 records 520a-520d matching the romanized name “Efim Belinskiy” were returned from the selected database. For database record 520a, the romanized database name 522 of the matching record is “BELINSKIY, EFIM.” This record matched the query name with a score 524 of 1 out of 1. Clicking on the hyperlinked record identification number (LAS ID) 526 creates a second window with further information about the matching record.

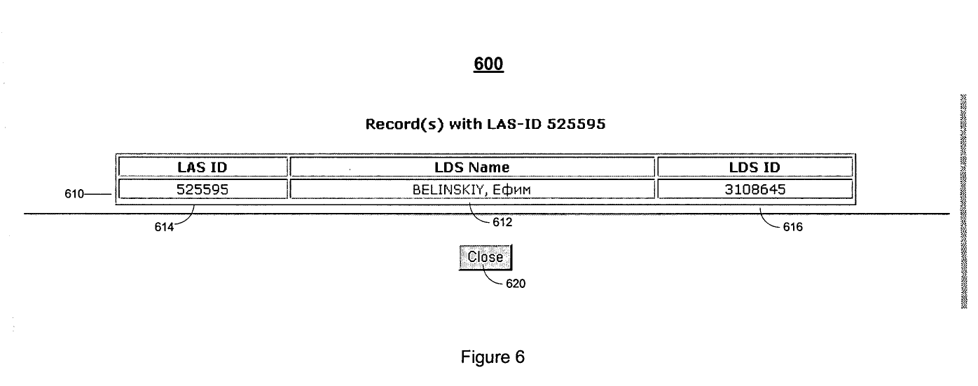

Referring to FIG. 6, an interface 600 contains records of names matching the query name. Record 610 was identified as a match for the query name “ [symbol] [symbol] .” The name 612 in the record is presented in its native orthographic form, which in this case is “BELINSKIY, [symbol] .” This name 612 is the NOF corresponding to the romanized name 522 from FIG. 5. In addition, two record identification numbers 614 and 616 are displayed as part of the record 610. Below the list of records is a “Close” button 620. Clicking on the “Close” button 620 will close the interface 600.

The roman writing system is used throughout as the base writing system to which all names are transliterated and in which all comparisons occur. However, any writing system can be used. For example, instead of romanizing the name to be searched, it could be transliterated into the Chinese writing system. Similarly, the database of names that could contain names in their Chinese forms rather than their roman forms. Thus the terms “romanizing,” “romanization,” and “roman” can be expanded in meaning to include any writing system.

Personal names have been used throughout of examples of input names that may be transliterated between writing systems such that names from a database that are related to the input names may be identified. However, names related to any type of name may be identified from the database, as long as the database includes the related names. For example, names related to business names may be identified from the database as long as the database includes entries relating native orthographic forms of business names to transliterated forms of business names. Business names that are received are transliterated, and the transliterated forms of the business names are matched against the transliterated forms of business names in the database to identify native orthographic forms of business names that match the received business names.

It will be understood that various modifications may be made without departing from the spirit and scope of the claims. For example, advantageous results still could be achieved if steps of the disclosed techniques were performed in a different order and/or if components in the disclosed systems were combined in a different manner and/or replaced or supplemented by other components. Accordingly, other implementations are within the scope of the following claims.

1. A system that identifies related names, comprising:
a datastore persistently storing a collection of names, at least one name within the datastore being represented both by a native orthographic form and by a transliterated form of the native orthographic form of the name;
an input interface structured and arranged to receive an input name;
a transliteration module structured and arranged to produce at least one transliterated form of the input name;
an identifier structured and arranged to identify at least one name from within the datastore that relates to the transliterated form of the input name; and
an output interface to present the at least one name identified from within the datastore as being related to the input name.

2. The system of claim 1 wherein at least one of the names in the datastore is derived through transliteration of a native orthographic form of the name.

3. The system of claim 1 wherein the at least one name maintained by the datastore is represented by the native orthographic form using a non-romanized version of the name and by the transliterated form using a romanized version of the name.

4. The system of claim 1 wherein the at least one name maintained by the datastore is represented by the native orthographic form using a non-romanized version of the name and by the transliterated form using a non-romanized version of the name.

5. The system of claim 1 wherein the at least one name maintained by the datastore is represented by the native orthographic form using a romanized version of the name and by the transliterated form using a romanized version of the name.

6. The system of claim 1 wherein the at least one name maintained by the datastore is represented by the native orthographic form using a romanized version of the name and by the transliterated form using a non-romanized version of the name.

7. The system of claim 1 wherein the input interface is structured and arranged to receive the input name in a native orthographic form, and the transliteration module is structured and arranged to generate one or more romanized forms of the input name from the native orthographic form of the input name received.

8. The system of claim 7 wherein the transliteration module is structured and arranged to identify a romanized version of a name that is input in a Cyrillic written form.

9. The system of claim 7 wherein the transliteration module is structured and arranged to identify a romanized version of a name that is input in an Arabic written form.

10. The system of claim 9 wherein the transliteration module is structured and arranged to identify a romanized version of a name that is input in an extension of the Arabic written form, such as a Farsi written form.

11. The system of claim 7 wherein the transliteration module is structured and arranged to identify a romanized version of a name that is input in a Chinese written form.

12. The system of claim 7 wherein the transliteration module is structured and arranged to identify a romanized version of a name that is input in a Hangul written form.

13. The system of claim 7 wherein the transliteration module is structured and arranged to identify a romanized version of a name that is input in a Roman written form.

14. The system of claim 7 wherein the transliteration module is structured and arranged to identify a romanized version of a name that is input in a Greek written form.

15. The system of claim 1 wherein:
the transliteration module is structured and arranged to produce multiple transliterated forms of a single input name, and
the identifier is structured and arranged to identify names from within the datastore that relate to more than one of the transliterated forms produced by the transliteration module for the single input name.

16. The system of claim 1 wherein the identifier is structured and arranged to match the transliterated form of the input name against similar forms of names stored in the datastore.

17. The system of claim 16 wherein the identifier is structured and arranged to assign a score to each of the similar forms of names stored in the database that matches the transliterated form of the input name, each of the scores indicating a quality of match between the transliterated form of the input name and the corresponding similar form.

18. The system of claim 16 wherein the transliterated form of the input name is roman, and the transliterated form of the names stored in the datastore is roman, such that the roman form of the input name is matched against the roman form of names stored in the datastore.

19. The system of claim 16 wherein the transliterated form of the input name is non-roman, and the transliterated form of the names stored in the datastore is non-roman, such that the non-roman form of the input name is matched against the non-roman form of names stored in the datastore.

20. The system of claim 16 wherein the identifier also is structured and arranged to identify native orthographic forms stored by the datastore that correspond to transliterated forms of one or more names within the datastore determined to match the transliterated form of the input name.

21. The system of claim 20 wherein the output interface is structured and arranged to produce the transliterated forms of the names within the datastore that are determined to match the transliterated form of the input name.

22. The system of claim 20 wherein the output interface is structured and arranged to produce the native orthographic form of the names identified as corresponding to the transliterated forms of names within the datastore that are determined to match the transliterated form of the input name.

23. The system of claim 22 wherein the output interface also is structured and arranged to produce the transliterated forms of the names within the datastore that are determined to match the transliterated form of the input name.

24. The system of claim 1 further comprising a module for dynamically selecting the transliteration schema from among several available transliteration schemas to be applied to the input name.

25. The system of claim 24 wherein the module for dynamically selecting the transliteration schema includes:
a module for determining a characteristic of the input name, and
a module for selecting the transliteration schema to be applied to the input name from among several available transliteration schemas based on the determined characteristic of the input name.

26. The system of claim 25 wherein the determined characteristic of the input name includes a candidate native orthographic form for the input name.

27. The system of claim 26 wherein the candidate native orthographic form of the input name is determined based on range of Unicode associated with one or more characters of the input name.

28. The system of claim 25 wherein the module determines independent characteristics for more than one segment of the input name, where segments of the input name independently correspond to different names within the entire input name.

29. The system of claim 28 wherein the module determines a first characteristic for a first segment of the input name and a second characteristic for a second segment of the input name, wherein the first and second characteristics differ.

30. The system of claim 29 wherein the first characteristic corresponds to a first candidate native orthographic form and the second characteristic corresponds to a second candidate native orthographic form that differs from the first candidate native orthographic form.

31. The system of claim 30 wherein the first and second candidate native orthographic forms represent native orthographic forms within a single language.

32. The system of claim 24 wherein the module for dynamically selecting the transliteration schema includes:
a module for determining characteristics of the names within the datastore; and
a module for selecting the transliteration schema to be applied to the input name from among several available transliteration schemas based on the determined characteristic of the names within the datastore.

33. The system of claim 32 wherein the module for determining characteristics of names within the datastore is structured and arranged to identify one or more particular transliteration forms of native orthographic forms of the stored names that appear frequently relative to other transliteration forms, and the module for selecting the transliteration schema to be applied to the input name selects a transliteration schema corresponding to the one or more particular transliteration forms identified.

34. The system of claim 33 wherein the module for dynamically selecting the transliteration module includes:
a module for receiving extrinsic data related to the native orthographic form of the input name; and
a module for selecting the transliteration schema to be applied to the input name from among several available transliteration schemas based on the received extrinsic data.

35. The system of claim 34 wherein the extrinsic data includes geographic data related to a person from whom the input name is received.

36. The system of claim 35 wherein the extrinsic data is derived from identifying documents presented by the person.

37. The system of claim 1 wherein the datastore comprises names corresponding to one or more languages, cultures, and coding schemes.

38. A method for identifying related names, comprising:
storing a collection of names, at least one stored name being represented both by a native orthographic form and by a transliterated form of the native orthographic form of the at least one name;
receiving an input name;
producing at least one transliterated form of the input name;
identifying at least one name from the collection that relates to the transliterated form of the input name; and
presenting the at least one name identified from the collection as being related to the input name.

39. The method of claim 38 wherein at least one of the stored names is derived through transliteration of a native orthographic form of the name.

40. The method of claim 38 wherein the at least one stored name is represented by the native orthographic form using a non-romanized version of the name and by the transliterated form using a romanized version of the name.

41. The method of claim 40 wherein:
receiving the input name comprises receiving the input name in the native orthographic form, and
producing the at least one transliterated form of the input name comprises producing one or more romanized forms of the input name from the native orthographic form of the input name received.

42. The method of claim 41 wherein producing the at least one transliterated form of the input name further comprises identifying a romanized version of a name that is input in a Cyrillic written form.

43. The method of claim 41 wherein producing at least one transliterated form of the input name further comprises identifying a romanized version of a name that is input in a Arabic written form.

44. The method of claim 38 wherein:
producing the at least one transliterated form of the input name comprises producing multiple transliterated forms of a single input name, and
identifying the at least one name that relates to the transliterated form of the input comprises identifying names that relate to more than one of the transliterated forms produced by the transliteration module for the single input name.

45. The method of claim 38 wherein identifying the at least one name that relates to the transliterated form of the input comprises matching the transliterated form of the input name against similar stored forms of names.

46. The method of claim 45 further comprising assigning a score to each of the similar stored forms of names that matches the transliterated form of the input name, each of the scores indicating a quality of match between the transliterated form of the input name and the corresponding similar form.

47. The method of claim 45 wherein the transliterated form of the input name is roman, and the transliterated form of the stored names is roman, such that the roman form of the input name is matched against the roman form of stored names.

48. The method of claim 45 wherein the transliterated form of the input name is non-roman, and the transliterated form of the stored names is non-roman, such that the non-roman form of the input name is matched against the non-roman form of stored names.

49. The method of claim 45 wherein identifying the at least one name that relates to the transliterated form of the input further comprises identifying stored native orthographic forms that correspond to transliterated forms of one or more stored names determined to match the transliterated form of the input name.

50. The method of claim 49 wherein presenting the at least one name identified as being related to the input name comprises producing the transliterated forms of the stored names that are determined to match the transliterated form of the input name.

51. The method of claim 50 wherein presenting the at least one name identified as being related to the input name comprises producing the native orthographic form of the names identified as corresponding to the transliterated forms of the stored names that are determined to match the transliterated form of the input name.

52. The method of claim 51 wherein presenting the at least one name identified as being related to the input name further comprises producing the transliterated forms of the stored names that are determined to match the transliterated form of the input name.

53. The method of claim 38 further comprising selecting dynamically the transliteration schema from among several available transliteration schemas to be applied to the input name.

54. The method of claim 53 wherein selecting dynamically the transliteration schema includes:
determining a characteristic of the input name, and
selecting the transliteration schema to be applied to the input name from among several available transliteration schemas based on the determined characteristic of the input name.

55. The method of claim 54 wherein the determined characteristic of the input name includes a candidate native orthographic form for the input name.

56. The method of claim 55 wherein the candidate native orthographic form of the input name is determined based on range of Unicode associated with one or more characters of the input name.

57. The method of claim 54 wherein determining the characteristic of the input name comprises determining independent characteristics for more than one segment of the input name, where segments of the input name independently correspond to different names within the entire input name.

58. The method of claim 57 wherein determining the characteristic of the input name further comprises determining a first characteristic for a first segment of the input name and a second characteristic for a second segment of the input name, wherein the first and second characteristics differ.

59. The method of claim 58 wherein the first characteristic corresponds to a first candidate native orthographic form and the second characteristic corresponds to a second candidate native orthographic form that differs from the first candidate native orthographic form.

60. The method of claim 59 wherein the first and second candidate native orthographic forms represent native orthographic forms within a single language.

61. The method of claim 53 wherein selecting the transliteration schema to be applied to the input name comprises:
determining characteristics of the stored names; and
selecting the transliteration schema to be applied to the input name from among several available transliteration schemas based on the determined characteristic of the stored names.

62. The method of claim 61 wherein:
determining characteristics of the stored names comprises identifying one or more particular transliteration forms of native orthographic forms of the stored names that appear frequently relative to other transliteration forms, and
selecting the transliteration schema to be applied to the input name comprises selecting a transliteration schema corresponding to the one or more particular transliteration forms identified.

63. The method of claim 53 wherein selecting the transliteration module comprises:
receiving extrinsic data related to the native orthographic form of the input name; and
selecting the transliteration schema to be applied to the input name from among several available transliteration schemas based on the received extrinsic data.

64. The method of claim 63 wherein the extrinsic data includes geographic data related to a person from whom the input name is received.

65. The method of claim 64 wherein the extrinsic data is derived from identifying documents presented by the person.

66. The method of claim 38 wherein the collection of names comprises names corresponding to one or more languages, cultures, and coding schemes.

67. A system that identifies related names, comprising:
datastore means for persistently storing a collection of names, at least one name within the datastore means being represented both by a native orthographic form and by a transliterated form of the native orthographic form of the name;
input interface means for receiving an input name;
transliteration means for producing at least one transliterated form of the input name;
identifier means for identifying at least one name from within the datastore means that relates to the transliterated form of the input name; and
an output interface means for presenting the at least one name identified from within the datastore means as being related to the input name.

68. A system that identifies related names, comprising:
a datastore persistently storing a collection of names formatted according to a first writing system;
an input interface capable of receiving an input name formatted according to a second writing system that differs from the first writing system;
a module for dynamically selecting a transliteration schema from among several available transliteration schemas to be applied to the input name;
a transliteration module structured and arranged to apply the selected transliteration schema to produce at least one transliterated form of the input name;
an identifier structured and arranged to identify at least one transliterated name from within the datastore that relates to the transliterated form of the input name; and
an output interface to present the at least one stored name identified from within the datastore as being related to the input name.

69. The system of claim 68 wherein at least one name within the datastore is derived from transliteration of the name from a writing system that differs from the first writing system.

70. The system of claim 69 wherein the name stored in the database has a native orthographic form prior to transliteration into the first writing system.

71. The system of claim 69 wherein the datastore stores the name in the writing system from which it was transliterated and in the first writing system.

72. The system of claim 68 wherein the module for dynamically selecting the transliteration schema is capable of selecting more than one transliteration schema to be applied to the input name by the transliteration module.

73. The system of claim 68 wherein the module for dynamically selecting the transliteration schema is capable of making an independent determination of a transliteration schema for each of several different segments of the input name.

74. The system of claim 68 wherein the module for dynamically selecting the transliteration schema includes:
a module for determining a characteristic of the input name, and
a module for selecting the transliteration schema to be applied to the input name from among several available transliteration schemas based on the determined characteristic of the input name.

75. The system of claim 74 wherein the determined characteristic of the input name includes a candidate native orthographic form for the input name.

76. The system of claim 75 wherein the candidate native orthographic form of the input name is determined based on range of Unicode associated with one or more characters of the input name.

77. The system of claim 74 wherein the module determines independent characteristics for more than one segment of the input name, where segments of the input name independently correspond to different names within the entire input name.

78. The system of claim 77 wherein the module determines a first characteristic for a first segment of the input name and a second characteristic for a second segment of the input name, wherein the first and second characteristics differ.

79. The system of claim 78 wherein the first characteristic corresponds to a first candidate native orthographic form and the second characteristic corresponds to a second candidate native orthographic form that differs from the first candidate native orthographic form.

80. The system of claim 79 wherein the first and second candidate native orthographic forms represent native orthographic forms within a single language.

81. The system of claim 68 wherein the module for dynamically selecting the transliteration schema includes:
a module for determining characteristics of the names within the datastore; and
a module for selecting the transliteration schema to be applied to the input name from among several available transliteration schemas based on the determined characteristic of the names within the datastore.

82. The system of claim 81 wherein the module for determining characteristics of names within the datastore is structured and arranged to identify one or more particular transliteration forms of native orthographic forms of the stored names that appear frequently relative to other transliteration forms, and the module for selecting the transliteration schema to be applied to the input name selects a transliteration schema corresponding to the one or more particular transliteration forms identified.

83. The system of claim 68 wherein the module for dynamically selecting the transliteration module includes:
a module for receiving extrinsic data related to the native orthographic form of the input name; and
a module for selecting the transliteration schema to be applied to the input name from among several available transliteration schemas based on the received extrinsic data.

84. The system of claim 83 wherein the extrinsic data includes geographic data related to a person from whom the input name is received.

85. The system of claim 84 wherein the extrinsic data is derived from identifying documents presented by the person.

86. A method for identifying related names, comprising:
persistently storing, in a datastore, a collection of names, each name representing a culture, a writing system, and a spelling convention;
receiving an input name, at least one of a culture, a writing system, or a spelling convention of the input name differing from the culture, the writing system, or the spelling convention of at least one of the names stored in the datastore;
dynamically selecting a transliteration schema from among several available transliteration schemas to be applied to the input name;
applying the selected transliteration schema to produce at least one transliterated form of the input name;
identifying at least one transliterated name from within the datastore that relates to the transliterated form of the input name; and
presenting the at least one stored name identified as being related to the input name.

87. The method of claim 86 further comprising deriving contents of the datastore by transliterating into the first writing system a name from a writing system that differs from the first writing system and storing at least results of the transliteration into the database.

88. The method of claim 87 wherein the name stored in the database has a native orthographic form prior to transliteration into the first writing system.

89. The method of claim 87 wherein persistently storing in the datastore includes storing the name in the writing system from which it was transliterated and in the first writing system.

90. The method of claim 86 wherein dynamically selecting the transliteration schema includes selecting more than one transliteration schema to be applied to the input name by the transliteration module.

91. The method of claim 86 wherein dynamically selecting the transliteration schema includes making an independent determination of a transliteration schema for each of several different segments of the input name.

92. The method of claim 86 wherein dynamically selecting the transliteration schema includes:
determining a characteristic of the input name, and
selecting the transliteration schema to be applied to the input name from among several available transliteration schemas based on the determined characteristic of the input name.

93. The method of claim 92 wherein the determined characteristic of the input name includes a candidate native orthographic form for the input name.

94. The method of claim 93 wherein the candidate native orthographic form of the input name is determined based on range of Unicode associated with one or more characters of the input name.

95. The method of claim 92 further comprising determining independent characteristics for more than one segment of the input name, where segments of the input name independently correspond to different names within the entire input name.

96. The method of claim 95 further comprising determining a first characteristic for a first segment of the input name and a second characteristic for a second segment of the input name, wherein the first and second characteristics differ.

97. The method of claim 96 wherein the first characteristic corresponds to a first candidate native orthographic form and the second characteristic corresponds to a second candidate native orthographic form that differs from the first candidate native orthographic form.

98. The method of claim 97 wherein the first and second candidate native orthographic forms represent native orthographic forms within a single language.

99. The method of claim 86 wherein dynamically selecting the transliteration schema includes:
determining characteristics of the names within the datastore; and
selecting the transliteration schema to be applied to the input name from among several available transliteration schemas based on the determined characteristic of the names within the datastore.

100. The method of claim 99 wherein determining characteristics of names within the datastore includes identifying one or more particular transliteration forms of native orthographic forms of the stored names that appear frequently relative to other transliteration forms, and selecting the transliteration schema to be applied to the input name includes selecting a transliteration schema corresponding to the one or more particular transliteration forms identified.

101. The method of claim 86 wherein dynamically selecting the transliteration module includes:
receiving extrinsic data related to the native orthographic form of the input name; and
selecting the transliteration schema to be applied to the input name from among several available transliteration schemas based on the received extrinsic data.

102. The method of claim 101 wherein the extrinsic data includes geographic data related to a person from whom the input name is received.

103. The method of claim 102 wherein the extrinsic data is derived from identifying documents presented by the person.

104. A system that identifies related names, comprising:
datastore means for persistently storing a collection of names formatted according to a first writing system;
input interface means for receiving an input name formatted according to a second writing system that differs from the first writing system;
means for dynamically selecting a transliteration schema from among several available transliteration schemas to be applied to the input name;
transliteration means for applying the selected transliteration schema to produce at least one transliterated form of the input name;
identifier means for identifying at least one transliterated name from within the datastore means that relates to the transliterated form of the input name; and
output interface means for presenting the at least one stored name identified from within the datastore means as being related to the input name.
